(19) United States
(12) Patent Application Publication
(10) Pub. No.: US 2007/0120932 A1
(43) Pub. Date: May 31, 2007

(54) Droplet ejection apparatus

(75) Inventor: Hirotsuna Miura, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/604,571

(22) Filed: Nov. 27, 2006

(30) Foreign Application Priority Data
Nov. 29, 2005 (JP) 2005-344648
Sep. 21, 2006 (JP) 2006-256167

(51) Int. Cl. B41J 2/01

(52) U.S. Cl. 347/102

(57) ABSTRACT

A droplet ejection apparatus has a droplet ejection head, a laser radiation device, and a suction device. The droplet ejection head ejects droplets of liquid onto a target. The laser radiation device radiates laser beams onto an area on the target opposed to the droplet ejection head. The suction device is provided between the laser radiation device and a radiating position on the target at which the laser beams are radiated, and draws elements that have evaporated from the droplets.

### CROSS-REFERENCE TO RELATED APPLICATIONS

This application is based upon and claims the benefit of priority from prior Japanese Patent Application Nos. 2005-344648 filed on Nov. 29, 2005, and 2006-256167 filed on Sep. 21, 2006, the entire contents of which are incorporated herein by reference.

### BACKGROUND

The present invention relates to a droplet ejection apparatus.

Typically, a display such as a liquid crystal display or an electroluminescence display includes a substrate that displays an image. The substrate has an identification code (for example, a two-dimensional code) representing product information including the name of the manufacturer and the product number, for purposes of quality control and production control. The identification code is formed by a plurality of dots arranged in such a manner as to form a prescribed pattern. As a method for forming one such identification code, JP-A-11-77340 discloses a laser sputtering method and JP-A-2003-127537 discloses a waterjet method. In the laser sputtering method, dots are formed by films provided through sputtering by radiating laser beams onto a metal foil. In the waterjet method, dots are marked on a substrate by ejecting water containing abrasive onto the substrate.

However, in the laser sputtering method, the interval between the metal foil and the substrate must be adjusted to several or several tens of micrometers in order to form each dot in a desired size. Thus, the substrate and the metal foil thus must have extremely flat surfaces and adjustment of the interval between the substrate and the metal foil must be carried out with accuracy on the order of micrometer. This limits application of the method to a restricted range of substrates, and use of the method is limited. In the waterjet method, the substrate may be contaminated by water, dust, and the abrasive that are splashed onto the substrate when the dots are marked on the substrate.

In order to solve these problems, an inkjet method has been focused on as an alternative method for forming the identification code. In the inkjet method, dots are formed on a substrate by ejecting droplets of liquid containing metal particles from an ejection head onto the substrate through nozzles. The droplets are then dried to mark the dots on the substrate. The method thus can be applied to a relatively wide range of substrates. Further, the method prevents contamination of the substrate caused by formation of the identification code.

In the inkjet method, the droplets quickly spread wet on the surface of the substrate in correspondence with the condition of the surface of the substrate or surface tension produced by the droplets after having been received by the substrate. Therefore, if the time necessary for drying the droplets exceeds a certain extent (for example, 100 milliseconds), the droplets excessively spread on the surface of the substrate and flow beyond the desired dot formation areas.

This problem is solved by radiating laser beams onto the droplets on the substrate, thus instantly solidifying the droplets. However, in this case, elements evaporated from the droplets may adhere to optical systems that radiate the laser beams, contaminating the optical systems. Therefore, a droplet ejection apparatus having a laser head that radiates laser beams must include a suction device that removes the evaporated elements. Specifically, the suction device draws and removes the floating evaporated elements from the vicinity of the laser head.

Generally, such techniques using a suction device for drawing floating evaporated elements from the vicinity of a droplet ejection head have been proposed. In this manner, excessive flowing of droplets is suppressed or mist generation in the vicinity of the droplet ejection head is avoided.

For example, as described in JP-A-2003-136689, a droplet ejection apparatus having a fan or a vacuum suction device has been proposed. After having been received by an ejection target, droplets are exposed to an air flow produced by the fan or the vacuum suction device, thus promoting drying of the droplets. Alternatively, as has been described in JP-A-2005-22194, a droplet ejection apparatus may include a suction device formed in a zone above a droplet ejection head. The suction device draws and removes volatile matter floating and remaining in the vicinity of the bottom surface of the droplet ejection head, together with the air. Further, JP-A-2003-145737 describes a droplet ejection apparatus that draws elements evaporated from the droplets through ultraviolet radiation. Such suction is performed at opposing sides of a printing sheet or a position downstream from an ultraviolet radiation area in a transport direction of the printing sheet.

The techniques described in JP-A-2003-136689 and JP-A-2005-22194 aim to prevent excessive spreading of droplets or mist generation. Therefore, the evaporated elements are removed from the vicinity of the droplets received by an ejection target or a droplet ejection head. However, the relationship between the flow path of the removed evaporated elements and the locations of the optical systems are not considered. Further, the apparatus described in JP-A-2003-145737 has optical systems including an electromagnetic radiant ray transmissible board and a reflective board. The electromagnetic radiant ray transmissible board guides ultraviolet rays from an ultraviolet lamp to the exterior. The reflective board reflects the ultraviolet rays and radiates the ultraviolet rays onto the droplets. Therefore, the technique is aimed to protect the optical systems. However, since the evaporated elements released at a position immediately below an electromagnetic radiation device are drawn from the opposing sides of the printing sheet or a at the position downstream from the radiation area, the evaporated elements that are not yet drawn pass immediately below the electromagnetic radiation device. Some of the elements thus adhere to and contaminate the optical systems.

Accordingly, the above-described typical droplet ejection apparatuses cannot prevent a droplet ejection head or optical systems that radiate laser beams from being contaminated by elements evaporated from droplets through laser radiation.

### SUMMARY

Accordingly, it is an objective of the present invention to provide a droplet ejection apparatus that stabilizes optical characteristics of laser beams radiated onto droplets of liquid.

In accordance with a first aspect of the present invention, a droplet ejection apparatus including a droplet ejection head, a laser radiation device, and a suction device is provided. The droplet ejection head ejects a droplet of a liquid onto a target. The laser radiation device radiates a laser beam onto an area on the target opposed to the droplet ejection head. The suction device is arranged between the laser radiation device and a radiating position on the target at which the laser beam is radiated, and draws an element that has evaporated from the droplet.

In accordance with another aspect of the present invention, a droplet ejection apparatus including a head unit and a movement device is provided. The head unit includes a droplet ejection head, a laser radiation device, and a suction port. The droplet ejection head ejects a droplet of a liquid onto a target. The laser radiation device radiates a laser beam onto an area on the target opposed to the droplet ejection head. The suction port is arranged between the droplet ejection head and the laser radiation device, and draws an element that has evaporated from the droplet through radiation of the laser beam. The movement device moves the head unit above the target in such a manner that the droplet ejection head precedes the suction port and the suction port precedes the laser radiation device.

Other aspects and advantages of the invention will become apparent from the following description, taken in conjunction with the accompanying drawings, illustrating by way of example the principles of the invention.

### BRIEF DESCRIPTION OF THE DRAWINGS

FIG. 1 is a plan view showing a droplet ejection apparatus;

FIG. 1A is an enlarged view showing the portion indicated by circle 1A of FIG. 1;

FIG. 2 is a perspective view schematically showing a droplet ejection apparatus according to one embodiment of the present invention;

FIG. 3 is a plan view schematically showing the droplet ejection apparatus of FIG. 2;

FIG. 5 is a view showing a droplet ejection head;

FIG. 6 is a view for explaining a head unit; and

FIG. 7 is a block diagram representing the electric configuration of the droplet ejection apparatus.

### DESCRIPTION OF EXEMPLARY EMBODIMENTS

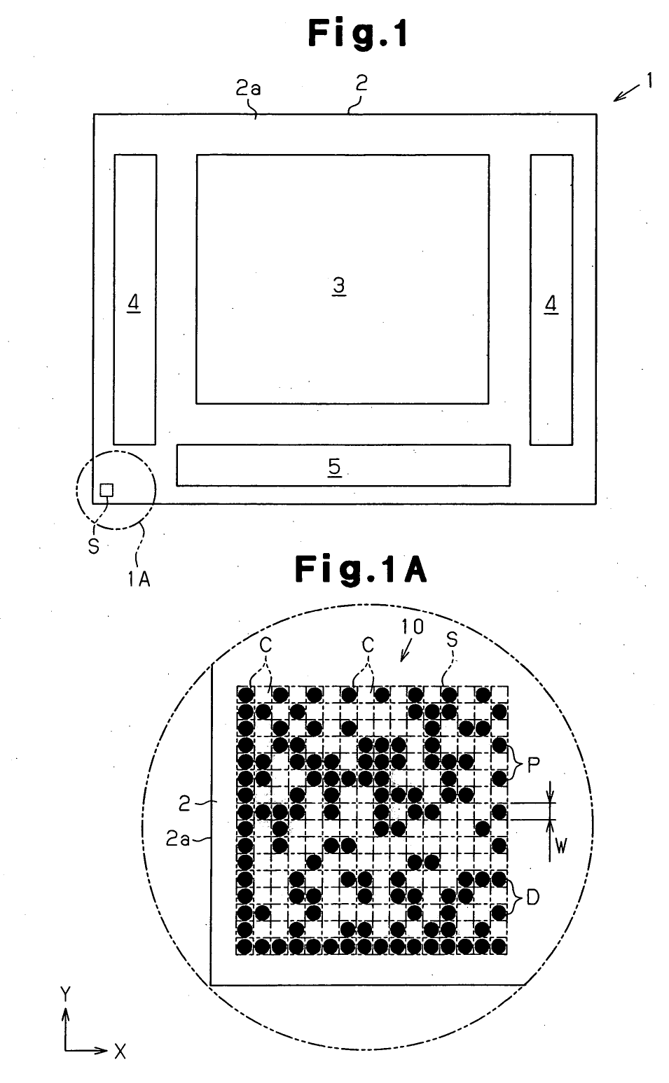

A first embodiment of the present invention will now be described with reference to FIGS. 1 to 7. A liquid crystal display 1 having an identification code 10 formed by a droplet ejection apparatus 20 of the present invention will first be explained.

As shown in FIG. 1, a rectangular display portion 3 in which liquid crystal molecules are sealed is formed substantially at the center of one side surface (a surface 2a) of a transparent substrate 2. A scanning line driver circuit 4 and a data line driver circuit 5 are provided outside the display portion 3. In correspondence with a scanning signal generated by the scanning line driver circuit 4 and a data signal produced by the data line driver circuit 5, the liquid crystal display 1 adjusts orientation of the liquid crystal molecules in the display portion 3. Area light emitted by a non-illustrated illumination device is modulated depending on the orientation of the liquid crystal molecules. Through such modulation, the liquid crystal display 1 displays a desired image on the display portion 3.

A code area S, which is a square each side of which is approximately one millimeter, is formed in the left corner of the surface 2a. The code area S is virtually divided into a plurality of cells C that form a matrix of 16 rows by 16 columns. A plurality of dots D, each of which is a mark, are formed in selected ones of the data cells C and thus define the identification code 10 of the liquid crystal display 1. In the first embodiment, the center of each of the data cells C in which the dots D are provided will be referred to as an “ejection target position P”. The length of each side of the data cell C will be referred to as the “cell width W”.

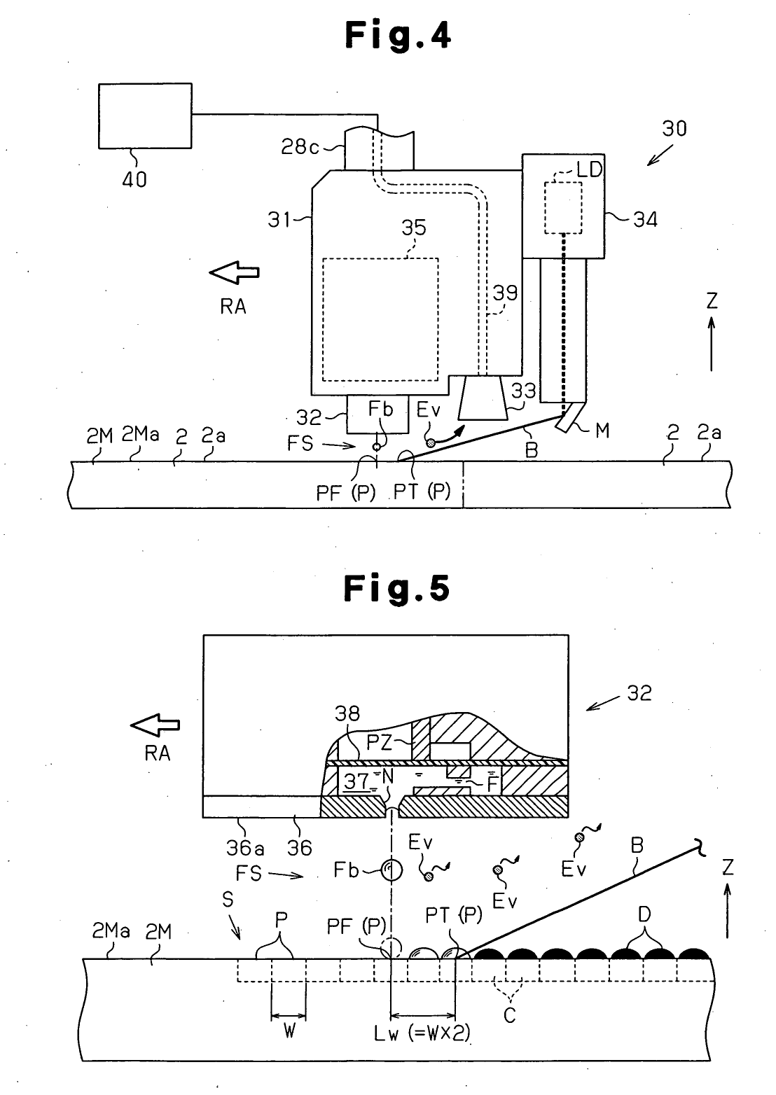

Each of the dots D is a mark and has a semispherical shape. The outer diameter of each dot D is equal to the length of each side of the data cell C (the “cell width W”). The outer diameter of each dot D is equal to the length of each side of each data cell C (the cell width W). Each dot D has a semispherical shape. A droplet Fb of liquid F (see FIG. 5) containing metal particles (for example, nickel or manganese particles) dispersed in dispersion medium is ejected onto each of the data cells C and received by the data cell C. Each of the dots D is formed by drying and baking the droplet Fb that has been received by each data cell C. Drying and baking of the droplet Fb in the data cell C is achieved by radiating a laser beam B (see FIG. 5) onto the droplet Fb.

The dots D formed in the selected data cells C are arranged in a certain pattern, in accordance of which the identification code 10 reproduces the product number and the lot number of the liquid crystal display 1. In the first embodiment, throughout FIGS. 1 to 5, the longitudinal direction of the transparent substrate 2 will be referred to as direction X and a direction perpendicular to direction X on a plane parallel with the substrate 2 will be referred to as direction Y. A direction perpendicular to directions X and Y will be referred to as direction Z. Particularly, the directions indicated by the arrows in the drawings will be referred to as direction +X, direction +Y, or direction +Z. The directions opposite to these directions will be referred to direction −X, direction −Y, or direction −Z.

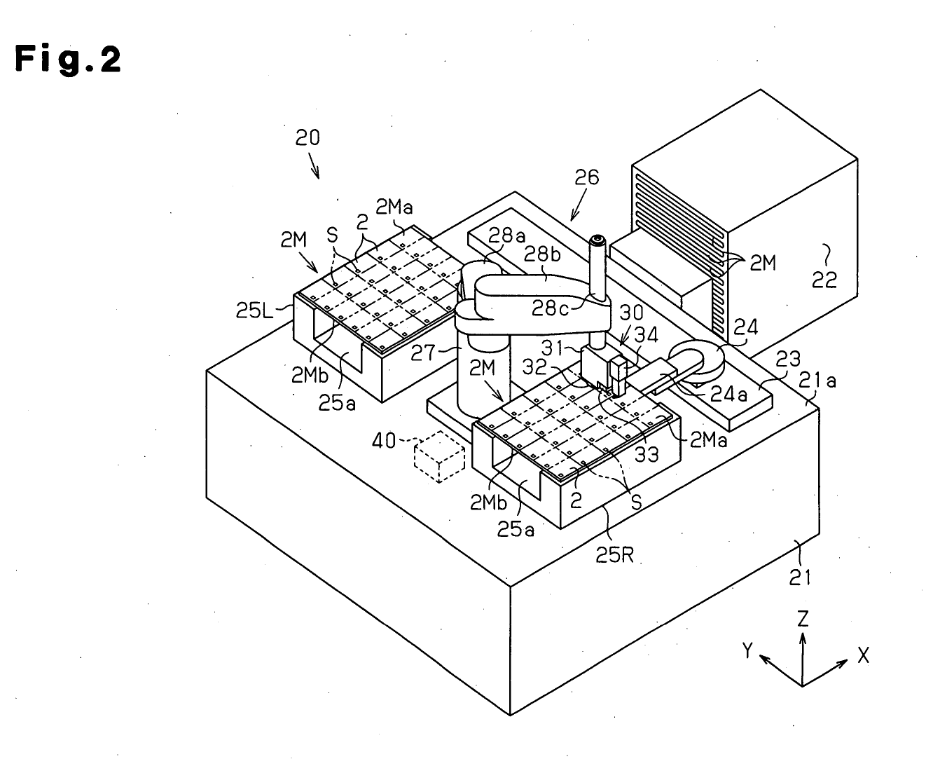

Next, the droplet ejection apparatus 20 for forming the identification code 10 will be described with reference to FIG. 2. In the illustrated embodiment, the identification codes 10 are formed at separate positions in correspondence with the transparent substrates 2 on the mother substrate 2M, which is a mother material of the multiple transparent substrates 2. The mother substrate 2M is a target onto which the droplets are ejected by the droplet ejection apparatus 20.

As shown in FIG. 2, the droplet ejection apparatus 20 has a base 21, which has a substantially parallelepiped shape. A substrate stocker 22, which receives multiple mother substrates 2M, is arranged at one side (in direction X) of the base 21. The substrate stocker 22 moves in an up-and-down direction as viewed in FIG. 2 (in direction +Z or direction−Z). This allows each of the mother substrates 2M to be retrieved from the substrate stocker 22, transported to the base 21, and returned to a corresponding slot of the substrate stocker 22.

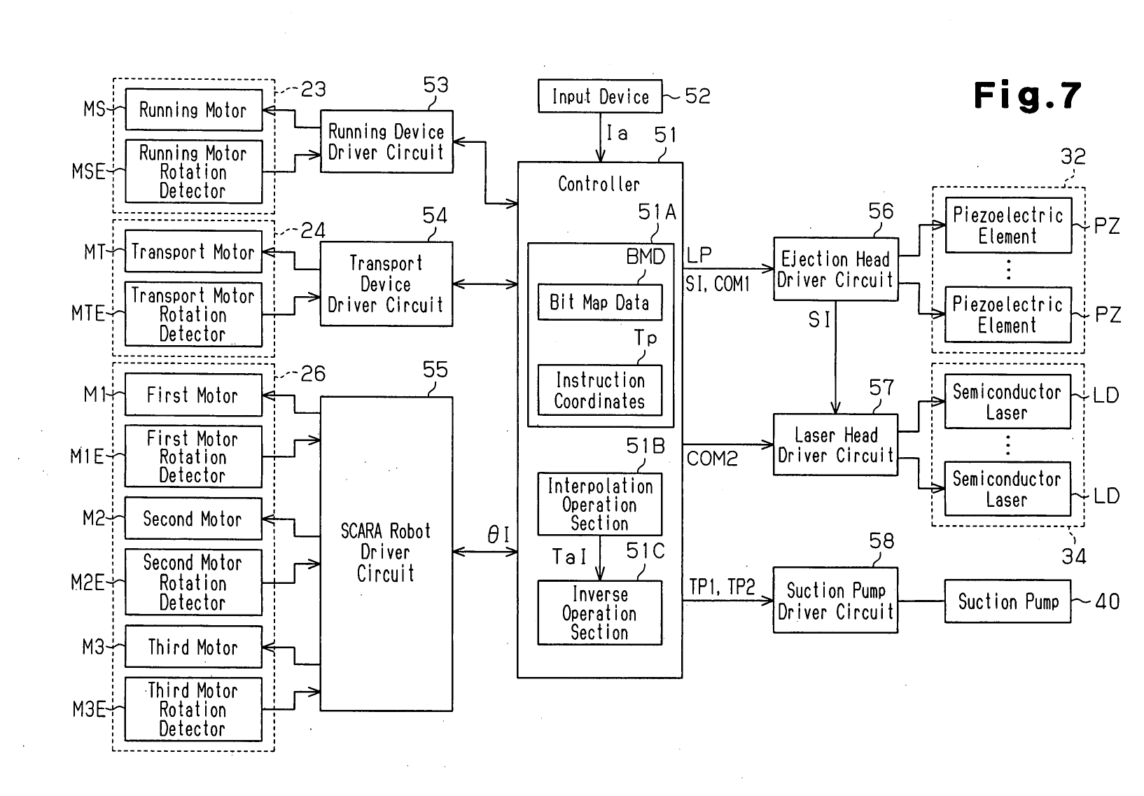

A running device 23, which extends in direction Y, is arranged on an upper surface 21a of the base 21 and at a position close to the substrate stocker 22. A running motor MS (see FIG. 7) is provided in the running device 23. The running device 23 operates a transport device 24, which is operably connected to the output shaft of the running motor MS, to run in direction Y. The transport device 24 is a horizontal articulated robot that has a transport arm 24a. The transport arm 24a draws and holds a backside 2Mb of each mother substrate 2M. A transport motor MT (see FIG. 7) is arranged in the transport device 24. The transport arm 24a is operably connected to the output shaft of the transport motor MT. The transport device 24 extends and contracts or pivots the transport arm 24a on the X-Y plane and raises or lowers the transport arm 24a.

A pair of mounting tables 25R, 25L are formed on the upper surface 21a of the base 21 at opposing sides in direction Y. The corresponding one of the mother substrates 2M is mounted on each of the mounting tables 25R, 25L with a surface 2Ma of the mother substrate 2M facing upward. Each mounting table 25R, 25L defines a space (a recess 25a) with respect to the backside 2Mb of the mother substrate 2M. The transport arm 24a can be received in and removed from the recess 25a. By moving upward or downward in the recess 25a, the transport arm 24a raises the mother substrate 2M from the mounting table 25R, 25L or places the mother substrate 2M on the mounting table 25R, 25L.

In response to prescribed control signals input to the running motor MS and the transport motor MT, the running device 23 and the transport device 24 retrieve the corresponding one of the mother substrates 2M from the substrate stocker 22 and place the mother substrate 2M on the corresponding one of the mounting tables 25R, 25L. Also, the running device 23 and the transport device 24 re-collect the mother substrates 2M by returning each mother substrate 2M from the mounting table 25R, 25L to a predetermined slot of the substrate stocker 22.

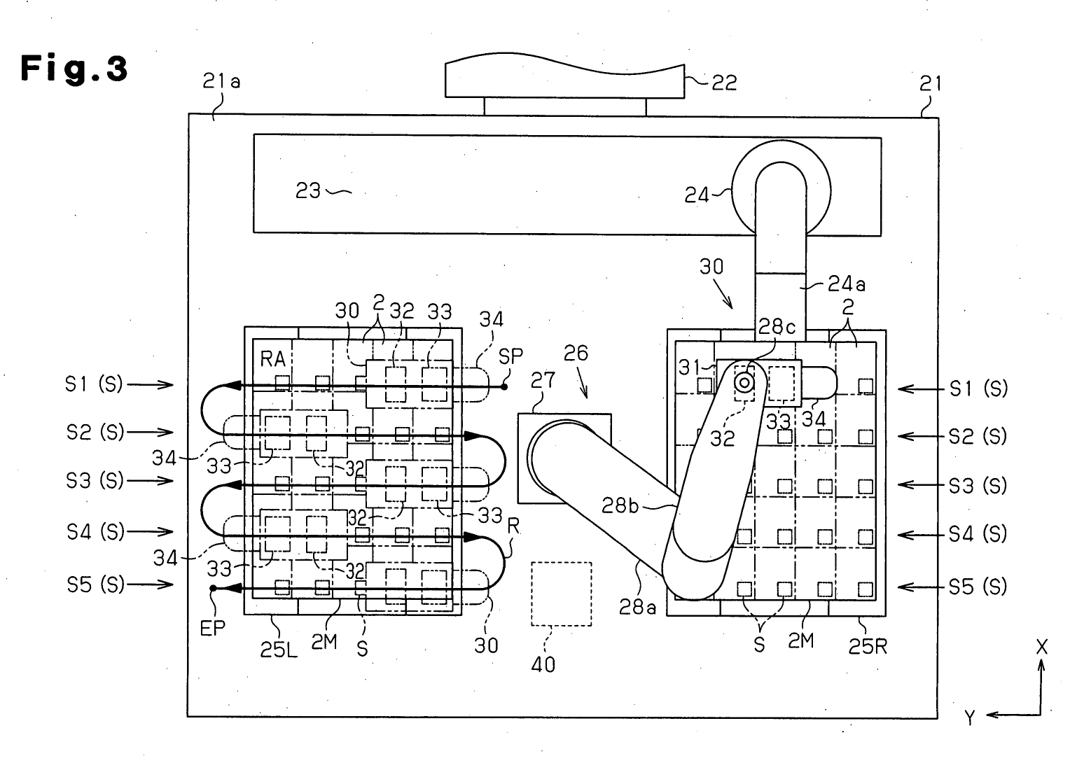

In the first embodiment, referring to FIG. 3, a code area S is defined on each of the mother substrates 2M mounted on the mounting tables 25R, 25L. In each mother substrate 2M, the rows of the code areas S are defined as the first row of the code areas S1, the second row of the code areas S2, the third row of the code areas S3, the fourth row of the code areas S4, and the fifth row of the code areas S5 sequentially in direction −X, or from the uppermost row to the lowermost row as viewed in FIG. 3.

As shown in FIG. 2, a multi-joint robot (hereinafter, referred to as a SCARA robot) 26, which functions as a movement mechanism, is arranged between the two mounting tables 25R, 25L and on the upper surface 21a of the base 21. The SCARA robot 26 has a main shaft 27 that is fixed to the upper surface 21a of the base 21 and extends upward (in direction +Z).

A first arm 28a is provided at the upper end of the main shaft 27. The proximal end of the first arm 28a is connected to the output shaft of a first motor M1 (see FIG. 7), which is provided in the main shaft 27. The first arm 28a pivots on a horizontal plane, or about a pivotal axis extending in direction Z. A second motor M2 (see FIG. 7) is provided at the distal end of the first arm 28a. The proximal end of a second arm 28b is connected to the output shaft of the second motor M2. This allows the second arm 28b to pivot on a horizontal plane, or about an axis extending in direction Z.

A third motor M3 (see FIG. 7) is arranged at the proximal end of the second arm 28b. A pillar-like third arm 28c is connected to the output shaft of the third motor M3 and thus pivots about a pivotal axis extending in direction Z. A head unit 30 is provided at the lower end of the third arm 28c.

The head unit 30 has a casing 31 having a box-like shape. A droplet ejection head (hereinafter, referred to simply as an ejection head) 32 and a suction port 33, which forms a suction device, are provided below the casing 31. A laser head 34, or a laser radiation device, is arranged at one side surface of the casing 31.

If the first, second, and third motors M1, M2, M3 receive prescribed control signals, the SCARA robot 26 pivots the corresponding first, second, and third arms 28a, 28b, 28c, thereby moving the head unit 30 in a predetermined area defined on the upper surface 21a.

Specifically, as shown in FIG. 3, the SCARA robot 26 generates a “target path R” in accordance with the position coordinates of the code areas S (the ejection target positions P) and operates the head unit 30 to perform scanning along the target path R. That is, as indicated by the arrows corresponding to the mounting table 25L of FIG. 3, the SCARA robot 26 pivots a first arm 28a, a second arm 28b, and a third arm 28c in such a manner as to deploy the head unit 30 (the distal end of the third arm 28c) at the “start point SP” in the first row of the code areas S1. In the drawing, the start point SP corresponds to the right end of the first row of the code areas S1. In this state, the laser head 34, the suction port 33, and the ejection head 32 are aligned in the head unit 30 in this order in direction +Y.

With the head unit 30 arranged at the start point SP, the SCARA robot 26 moves the head unit 30 in direction +Y. In other words, the SCARA robot 26 operates the head unit 30 in such a manner that the ejection head 32 precedes the suction port 33 and the suction port 33 precedes the laser head 34. When the head unit 30 reaches the end point in the first row of the code areas S1, the SCARA robot 26 pivots the first, second, and third arms 28a, 28b, 28c, thus rotating the head unit 30 counterclockwise at 180 degrees outside the mother substrate 2M and sending the head unit 30 to the start point in the second row of the code areas S2 (the left end as viewed in FIG. 3). In this state, in the head unit 30, the laser head 34, the suction port 33, and the ejection head 32 are aligned in this order in direction −Y.

When the head unit 30 is deployed at the start point in the second row of the code areas S2, the SCARA robot 26 pivots the first, second, and third arms 28a, 28b, 28c in such a manner as to move the head unit 30 in direction −Y. In other words, as in the case of scanning in the first row of the code areas S1, the SCARA robot 26 operates the head unit 30 in such a manner that the ejection head 32 precedes the suction port 33 and the suction port 33 precedes the laser head 34. Afterwards, in the same manner as has been described, the SCARA robot 26 operates the head unit 30 to scan the third, fourth, and fifth rows of the code areas S3, S4, S5 in this order in direction Y, until the head unit 30 reaches the end point EP of the fifth row of the code areas S5.

Accordingly, while moving the head unit 30 along the “target path R” having a zigzag shape, the SCARA robot 26 operates in such a manner that the suction port 33 constantly precedes the laser head 34. In the illustrated embodiment, the scanning direction of the head unit 30 is defined as the “scanning direction RA”.

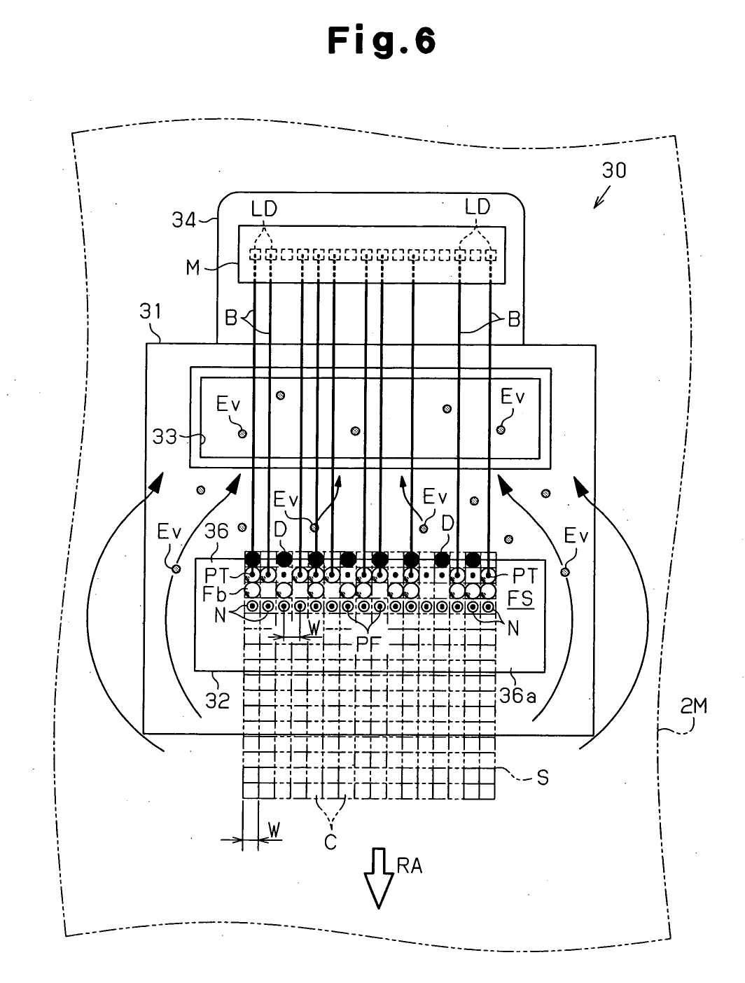

FIGS. 4 and 5 are views each showing the head unit 30, and FIG. 6 is a plan view schematically showing the head unit 30 as viewed from the side corresponding to the mother substrate 2M.

As shown in FIG. 4, the casing 31 has a liquid tank 35 that retains liquid F (see FIG. 5). The droplet ejection head 32 is arranged below the casing 31. The liquid F is supplied from the liquid tank 35 to the ejection head 32.

As shown in FIG. 5, a nozzle plate 36 is provided at the lower surface of the ejection head 32. A plurality of circular bores (nozzles N) are defined in the lower surface (a nozzle surface 36a) of the nozzle plate 36, extending in a normal direction of the mother substrate 2M (direction Z) through the nozzle plate 36. As shown in FIG. 6, the nozzles N are aligned in a direction perpendicular to the scanning direction RA of the head unit 30. The pitch of the nozzles N is equal to the cell width W. In the illustrated embodiment, the positions on the mother substrate 2M opposed to the nozzles N will be referred to as the droplet receiving positions PF.

As illustrated in FIG. 5, the ejection head 32 has cavities 37 that are defined above the nozzles N and communicate with the liquid tank 35. Each of the cavities 37 supplies the liquid F from the liquid tank 35 to the corresponding one of the nozzles N. An oscillation plate 38 is bonded with the upper sides of the walls defining each cavity 37. The oscillation plates 38 each oscillate in the up-and-down direction in such a manner as to increase and decrease the volume of the corresponding one of the cavities 37. A plurality of piezoelectric elements PZ are arranged on the oscillation plates 38 in correspondence with the nozzles N. When the droplet receiving positions PF coincide with the ejection target positions P and in response to a prescribed drive signal (drive voltage COM1: see FIG. 7) input to each of the piezoelectric elements PZ, the piezoelectric element PZ contracts and extends in the up-and-down direction, oscillating the associated oscillation plate 38. Specifically, through contraction and extension of each piezoelectric element PZ, the interface (the meniscus) of the liquid F in the corresponding nozzle N oscillates in the up-and-down direction. In this manner, a droplet Fb the weight of which corresponds to the drive voltage COM1 is ejected from the nozzle N. The ejected droplet Fb travels in the space (the traveling zone FS) between the nozzle plate 36 and the mother substrate 2M in direction −Z, reaching the corresponding droplet receiving position PF, or ejection target position P. The droplet Fb then spreads wet on the surface 2Ma and the outer diameter of the droplet Fb becomes equal to the cell width W.

In the illustrated embodiment, the time from when ejection of the droplets Fb starts to when the outer diameter of each droplet Fb becomes equal to the cell width W will be referred to as the “radiation standby time”. Movement of the head unit 30 during the “radiation standby time” covers the distance (the radiation standby distance Lw) double the cell width W.

As shown in FIG. 4, the suction port 33 has a box-like shape and has a lower opening. The suction port 33 communicates with a suction tube 39 extending in the casing 31. The suction tube 39 passes through the interiors of the third arm 28c, the second arm 28b, the first arm 28a, and the main shaft 27 and is connected to a suction pump 40 (see FIGS. 2 and 3) in the base 21. In other words, the suction port 33 communicates with the suction pump 40 through the suction tube 39.

In response to a suction start signal input to the suction pump 40, the suction pump 40 starts suction. The gas in the space between the suction port 33 and the mother substrate 2M is thus drawn from the suction port 33 to the suction pump 40 through the suction tube 39. The gap between the ejection head 32 and the mother substrate 2M is relatively narrow. Thus, in the zone between the ejection head 32 and the mother substrate 2M, or the traveling zone FS, the flow resistance of the gas becomes great with respect to that in the area around the traveling zone FS. Therefore, when the gas is drawn from the suction port 33, the gas forward from the suction port 33 in the scanning direction RA reaches the suction port 33 while avoiding the area in which the flow resistance is great, or the traveling zone FS. Accordingly, in suction of the gas by the suction pump 40, the flow of the gas in the traveling zone FS is suppressed, stabilizing the traveling direction of the droplets Fb ejected by the ejection head 32.

As shown in FIG. 4, a plurality of lasers, which are a plurality of semiconductor lasers LD in this embodiment, are arranged in the laser head 34 in correspondence with the nozzles N and aligned in the alignment direction of the nozzles N. In response to a drive signal (drive voltage COM2: see FIG. 7) input to the semiconductor lasers LD, the semiconductor lasers LD each radiate a laser beam B downward in direction Z. The laser beam B falls in the wavelength range corresponding to the absorption wavelength of the droplets Fb. A reflective mirror M as an optical system is provided at the lower end of the laser head 34 and immediately below the array of the semiconductor lasers LD in correspondence with the array of the semiconductor lasers LD. The reflective mirror M extends along the alignment direction of the nozzles N. The reflective mirror M totally reflects the laser beams B radiated by the semiconductor lasers LD and sends the laser beams B in a diagonally downward direction with respect to the scanning direction RA of the head unit 30. That is, the laser beam B radiated by each semiconductor laser LD is guided to the position on the mother substrate 2M forward from the position on the mother substrate 2M immediately below the semiconductor laser LD in the scanning direction RA of the head unit 30.

Referring to FIG. 5, in the illustrated embodiment, the position at which the surface 2Ma of the mother substrate 2M crosses the optical axis of each laser beam B proceeding diagonally downward is defined as a radiating position PT. The distance between the radiating position PT and the corresponding droplet receiving position PF is set to the radiation standby distance Lw. In other words, by the time the radiation standby time elapses since reception of a droplet Fb at the ejection target position P, the radiating position PT reaches the droplet Fb that has reached the ejection target position P.

Each semiconductor laser LD receives the drive voltage COM2 to radiate the laser beam B when the corresponding radiating position PT coincides with the ejection target position P. The laser beam B is totally reflected by the reflective mirror M and irradiates the droplet Fb at the corresponding radiating position PT. The laser beam B thus evaporates the solvent or the dispersion medium from the droplet Fb as evaporated elements Ev and bakes the metal particles of the droplet Fb. In this manner, a dot D having an outer diameter equal to the cell width W of each data cell C is formed at the ejection target position P.

With reference to FIG. 6, the evaporated elements Ev float in the vicinity of the radiating positions PT between the nozzles N and the reflective mirror M, as viewed in a normal direction of the mother substrate 2M. The floating evaporated elements Ev are drawn through the suction port 33, which is rearward from the nozzles N in the scanning direction RA, in the direction opposite to the scanning direction RA. That is, the evaporated elements Ev are drawn in the direction opposite to the movement direction of the nozzles N in such a manner as to separate the evaporated elements Ev from the nozzles N. The suction port 33 is located forward from the reflective mirror M in the scanning direction RA. Therefore, the floating evaporated elements Ev are drawn through the suction port 33 at positions forward from the reflective mirror M (the laser head 34) in the movement direction of the reflective mirror M (the laser head 34). This prevents the reflective mirror M from being exposed to the evaporated elements Ev.

Accordingly, adhesion of the evaporated elements Ev to the nozzles N and the reflective mirror M is avoided. This ensures stable ejection of the droplets Fb by the ejection head 32 and stabilizes optical characteristics of the optical systems that provide the laser beams B. The laser beams B are thus effectively radiated onto a desired point at a desired intensity.

The electric configuration of the droplet ejection apparatus 20, the structure of which has been described so far, will hereafter be explained with reference to FIG. 7.

As shown in FIG. 7, the droplet ejection apparatus 20 has a controller 51 including a CPU, a ROM, and a RAM. In accordance with the current position of the distal end of the third arm 28c (the ejection head 32) and different control programs, the controller 51 operates the running device 23, the transport device 24, and the SCARA robot 26 while actuating the ejection head 32 and the laser head 34.

An input device 52 having manipulation switches such as a start switch and a stop switch is connected to the controller 51. Through the input device 52, information regarding the identification code 10 is input to the controller 51 as a prescribed form of imaging data Ia. The controller 51 generates bit map data BMD by processing the imaging data Ia provided by the input device 52. In accordance with the bit map data BMD, the controller 51 generates the position coordinates (instruction coordinates Tp) of each of the ejection target positions P. The position coordinates (the instruction coordinates Tp) are provided in correspondence with an orthogonal coordinate system. Further, the controller 51 subjects the imaging data Ia to a process different from the process for the bit map data BMD, thus generating the drive voltage COM1 for the piezoelectric elements PZ and the drive voltage COM2 for the semiconductor lasers LD.

The controller 51 has a memory 51A that stores data such as the bit map data BMD and a program for forming the identification code 10.

The bit map data BMD indicates whether to eject the droplets Fb onto the areas provided by virtually dividing an imaging plane defined on the orthogonal coordinate system (the surface 2Ma of the mother substrate 2M). In other words, the bit map data BMD is used for instructing whether to actuate the piezoelectric elements PZ in accordance with the value of each bit (0or 1). The bit map data BMD is thus used for instructing whether to eject the droplets Fb from the nozzles N when the ejection head 32 scans the first to fifth rows of the code areas S1 to S5.

The controller 51 serially transfers the ejection control signals SI produced by synchronizing the bit map data BMD with a prescribed clock signal to the ejection head driver circuit 56.

The controller 51 has an interpolation operation section 51B. The interpolation operation section 51B performs an interpolation process (for example, linear or circular interpolation) on a space between each adjacent pair of the instruction coordinates Tp at prescribed interpolation cycles. The interpolation operation section 51B thus calculates the position coordinates (the interpolation coordinates) of each of interpolation points that form the target path R. The interpolation operation section 51B calculates information (path information TaI) including the instruction coordinates Tp and the interpolation coordinates and outputs the path information TaI to an inverse operation section 51C.

The inverse operation section 51C sequentially calculates pivotal angles and other parameters of the motors M1, M2, M3 in accordance with the path information TaI, which has been output from the interpolation operation section 51B, in such a manner that the position of the distal end of the third arm 28c sequentially coincides with the instruction coordinates Tp and the interpolation coordinates. In other words, the inverse operation section 51C sequentially calculates information (arm pivot information θI) that can provide the posture of the SCARA robot 26 that allows the suction port 33 to precede the laser head 34 in the scanning direction RA when the head unit 30 moves along the target path R. The inverse operation section 51C outputs the calculated arm pivot information θI to the SCARA robot driver circuit 55.

A running device driver circuit 53 is connected to the controller 51. The running device driver circuit 53 is connected to the running motor MS and a running motor rotation detector MSE. In response to a control signal from the controller 51, the running device driver circuit 53 operates to rotate the running motor MS in a forward direction or a reverse direction. The controller 51 also calculates the movement direction and the movement amount of the transport device 24 in correspondence with a detection signal generated by the running motor rotation detector MSE.

A transport device driver circuit 54 is connected to the controller 51. The transport device driver circuit 54 is connected to the transport motor MT and a transport motor rotation detector MTE. In response to a control signal from the controller 51, the transport device driver circuit 54 operates to rotate the transport motor MT in a forward direction or a reverse direction. Further, the controller 51 calculates the movement direction and the movement amount of the transport arm 24a in correspondence with a detection signal received from the transport motor rotation detector MTE.

A SCARA robot driver circuit 55 is connected to the controller 51. The SCARA robot driver circuit 55 is connected to the first motor M1, the second motor M2, and the third motor M3. In response to inputting of the arm pivot information θI from the controller 51, the SCARA robot driver circuit 55 operates to rotate the first, second, and third motors M1, M2, M3 in a forward direction or a reverse direction. The SCARA robot driver circuit 55 is connected also to a first motor rotation detector M1E, a second motor rotation detector M2E, and a third motor rotation detector M3E. In correspondence with detection signals provided by the first, second, and third motor rotation detectors M1E, M2E, M3E, the SCARA robot driver circuit 55 computes the movement direction and the movement amount of the distal end of the third arm 28c (the ejection head 32).

The controller 51 moves the head unit 30 in a zigzag manner along the target path R through the SCARA robot driver circuit 55. The controller 51 outputs different control signals in correspondence with the calculation result (the current position of the ejection head 32) obtained by the SCARA robot driver circuit 55.

Specifically, the controller 51 generates a signal that instructs activation of the suction pump 40 (a start signal TP1) and sends the signal to a suction pump driver circuit 58 in correspondence with the timing at which scanning by the head unit 30 starts, or the ejection head 32 is located at the start point SP.

Further, the controller 51 generates a signal (an ejection timing signal LP) that instructs ejection of the droplets Fb and sends the signal to an ejection head driver circuit 56 in correspondence with the timing at which the ejection head 32 is (the droplet receiving positions PF are) located in the corresponding code area S (at the corresponding ejection target positions P).

Further, the controller 51 generates a signal (a stop signal TP2) that instructs deactivation of the suction pump 40 and provides the signal to the suction pump driver circuit 58 in correspondence with the timing at which scanning of the head unit 30 ends, or the ejection head 32 is located at the end point EP.

The ejection head driver circuit 56 is connected to the controller 51. The controller 51 sends the ejection timing signal LP to the ejection head driver circuit 56 and supplies the drive voltage COM1 to the ejection head driver circuit 56 synchronously with the ejection timing signal LP. The controller 51 also serially transfers the ejection control signals SI to the ejection head driver circuit 56. The ejection head driver circuit 56 converts the ejection control signals SI in the serial forms to parallel signals in such a manner that the parallel ejection control signals SI correspond to the piezoelectric elements PZ.

After receiving the ejection timing signal LP from the controller 51, the ejection head driver circuit 56 supplies the drive voltage COM1 to those of the piezoelectric elements PZ that are selected in accordance with the parallel ejection control signals SI, which have been converted from the serial forms. Further, in response to the ejection timing signal LP input from the controller 51, the ejection head driver circuit 56 outputs the parallel ejection control signal SI to a laser head driver circuit 57.

The laser head driver circuit 57 is connected to the controller 51. The controller 51 supplies the drive voltage COM2 to the laser head driver circuit 57 synchronously with the ejection timing signal LP. After having received the ejection control signals SI from the ejection head driver circuit 56, the laser head driver circuit 57 stands by for a predetermined time, or the radiation standby time. The laser head driver circuit 57 then supplies the drive voltage COM2 to the semiconductor lasers LD corresponding to the ejection control signals SI.

When the ejection control signals SI are received by the laser head driver circuit 57, the controller 51 instructs the laser head driver circuit 57 to stand by for the radiation standby time and operates the head unit 30 to scan for the radiation standby time. After the radiation standby time, or when the radiating positions PT coincide with the corresponding droplet receiving target positions P, the controller 51 operates the laser head driver circuit 57 to radiate the laser beams B from the laser head 34 onto the droplets at the droplet receiving target positions P.

The suction pump driver circuit 58 is connected to the controller 51. The controller 51 outputs a corresponding control signal (the start signal TP1 or the end signal TP2) to the suction pump driver circuit 58. The suction pump driver circuit 58 is connected to the suction pump 40. In response to the start signal TP1 from the controller 51, the suction pump driver circuit 58 starts suction by the suction pump 40. In response to the end signal TP2 from the controller 51, the suction pump driver circuit 58 stops the suction by the suction pump 40. While moving the head unit 30 along the target path R, the controller 51 activates the suction pump 40 to continuously perform suction through the suction port 33.

A procedure for forming the identification codes 10 using the droplet ejection apparatus 20 will hereafter be explained.

First, the imaging data Ia is input to the controller 51 by manipulating the input device 52. The controller 51 then drives the running device 23 and the transport device 24 to retrieve the corresponding mother substrate 2M from the substrate stocker 22 and place the mother substrate 2M on the mounting table 25R (or the mounting table 25L). Further, by processing the imaging data Ia sent from the input device 52, the controller 51 generates the bit map data BMD and the instruction coordinates Tp. The controller 51 then stores the bit map data BMD and the instruction coordinates Tp in the memory 51A.

Further, the controller 51 operates the SCARA robot driver circuit 55 to move the distal end of the third arm 28c to the start point SP. Meanwhile, the controller 51 sequentially calculates the interpolation coordinates between each group of the instruction coordinates Tp and the subsequent instruction coordinates Tp, with the start point SP of the first row of the code areas S1 as a start point. The controller 51 outputs path information TaI consisting of the interpolation coordinates and the instruction coordinates Tp to the inverse operation section 51C. The inverse operation section 51C sequentially generates the arm pivot information ΘI corresponding to the interpolation coordinates and the instruction coordinates Tp.

When the distal end of the third arm 28c (the ejection head 32) is arranged at the start point SP, the controller 51 sends the start signal TP1 to the suction pump driver circuit 58 in such a manner as to start suction by the suction pump 40 through the suction port 33.

When the ejection head 32 is located at the start point SP, the controller 51 sequentially provides the arm pivot information θI to the SCARA robot driver circuit 55 through the inverse operation section 51C. This causes the head unit 30 to start scanning. Specifically, while maintaining the position of the suction port 33 between the laser head 34 and the droplet ejection head 32, the controller 51 starts scanning of the head unit 30 along the target path R from the start point SP.

In correspondence with the calculation results obtained by the SCARA robot driver circuit 55, the controller 51 determines whether the droplet receiving positions PF have reached the foremost ones of the ejection target positions P in the first row of the code areas S1. The foremost ones of the ejection target positions P correspond to the rightmost column of the data cells C in the rightmost code area S of the first row of the code areas S1, as viewed in FIG. 3. Also, the controller 51 provides the ejection control signals SI and the drive voltage COM1 to the ejection head driver circuit 56 and the drive voltage COM2 to the laser head driver circuit 57.

When the droplet receiving positions PF coincide with the foremost ones of the ejection target positions P in the first row of the code areas S1, the controller 51 outputs the ejection timing signal LP to the ejection head driver circuit 56 and supplies the drive voltage COM1 to those of the piezoelectric elements PZ that are selected in accordance with the ejection control signals SI. In response to such supply of the drive voltage COM1, those of the nozzles N that are selected in accordance with the ejection control signals SI simultaneously eject the droplets Fb. The ejected droplets Fb travel in the traveling zone FS and reach the surface 2Ma of the mother substrate 2M.

Specifically, since the gas flow in the traveling zone FS is suppressed, the droplets Fb reach the corresponding ejection target positions P without becoming offset from the traveling path. After having reached the corresponding ejection target position P, each droplet Fb spreads wet in the corresponding data cell C in such a manner that the outer diameter of the droplet Fb becomes equal to the cell width W after the radiation standby time has elapsed since the start of ejection.

Further, the controller 51 sends the parallel ejection control signals SI, which have been converted from the serial forms, to the laser head driver circuit 57 through the ejection head driver circuit 56. After the radiation standby time has elapsed since the start of ejection, or when the radiating positions PT coincide with the corresponding ejection target positions P, the controller 51 supplies the drive voltage COM2 to those of the semiconductor lasers LD that are selected in accordance with the ejection control signals SI. In response to such supply of the drive voltage COM2, the selected semiconductor lasers LD simultaneously radiate the laser beams B. The laser beams B are then totally reflected by the reflective mirror M and thus radiate the droplets Fb that are located at the corresponding radiating positions PT, or ejection target positions P, and have the outer diameter equal to the cell width W. This causes evaporation (drying) of the solvent or the dispersion medium from the droplets Fb and baking of the metal particles in the droplets Fb. As a result, each of the droplets Fb is fixed to the surface 2Ma as a dot D having the outer diameter equal to the cell width W. In this manner, the dots D are provided in correspondence with the cell width W.

Specifically, the evaporated elements Fv floating in the vicinity of the radiating positions PT are drawn by the suction port 33, which is rearward from the nozzles N but forward from the reflective mirror M in the scanning direction RA. The evaporated elements Ev are thus removed from the space between the nozzles N (the ejection head 32) and the reflective mirror M (the laser head 34) without reaching the nozzles N (the ejection head 32) and the reflective mirror M (the laser head 34).

Afterwards, the controller 51 operates to move the head unit 30 along the target path R in the same manner as has been described, with the suction port 33 maintained at a position between the laser head 34 and the droplet ejection head 32 in the scanning direction RA. Each time the droplet receiving positions PF coincide with the ejection target positions P, the controller 51 operates the selected nozzles N to eject the droplets Fb. When the outer diameter of each droplet Fb becomes equal to the cell width W, the controller 51 operates to radiate the laser beams B onto the droplets Fb. In this manner, the dots D are provided in each of the code areas S on the mother substrate 2M in such a manner as to form a prescribed pattern, while preventing the nozzles N (the ejection head 32) and the reflective mirror M (the laser head 34) from being contaminated by the evaporated elements Ev.

When the head unit 30 reaches the end point EP after having completed formation of the dots D on the mother substrate 2M, the controller 51 outputs the suction end signal TP2 to the suction pump driver circuit 58, thus stopping suction by the suction pump 40 through the suction port 33. The controller 51 then operates the running device 23 and the transport device 24 to transport the mother substrate 2M on which the dots D have been formed to the substrate stocker 22, ending formation of the identification codes 10 on the mother substrate 2M.

The illustrated embodiment has the following advantages.

(1) The suction port 33, which draws the evaporated elements Fv, is arranged forward from the laser head 34 (the reflective mirror M) in the scanning direction RA. Therefore, the evaporated elements Ev released from the droplets Fv through radiation of the laser beams B are drawn through the suction port 33 at a position forward from the laser head 34 (the reflective mirror M) in the scanning direction RA. This prevents the evaporated elements Ev from adhering to the laser head 34 (the reflective mirror M). Contamination of the reflective mirror M by the evaporated elements Ev is thus avoided, stabilizing the optical characteristics of the reflective mirror M. This improves controllability for shaping the dots D formed by the droplets Fb.

(2) The suction port 33 is arranged between the laser head 34 (the reflective mirror M) and the radiating positions PT. Therefore, compared to the case in which the suction port 33 is located forward from the radiating positions PT in the scanning direction RA, the evaporated elements Ev proceeding toward the reflective mirror M are reliably removed before reaching the reflective mirror M. This further stabilizes the optical characteristics of the reflective mirror M.

(3) The radiating positions PT of the laser beams B are set at the positions opposed to the ejection head 32. The suction port 33 is located between the ejection head 32 and the laser head 34. The evaporated elements Fv proceeding toward the ejection head 32 (the nozzles N) are thus reliably drawn through the suction port 33, preventing contamination of the ejection head 32 (the nozzles N) by the evaporated elements Ev. This stabilizes ejection of droplets.

(4) The flow resistance of the gas moving from the mother substrate 2M to the suction port 33 is increased in the traveling zone FS. This suppresses flow of the gas in the traveling zone FS when the evaporated elements Ev are drawn through the suction port 33. The traveling direction of the droplets Fb ejected from the ejection head 32 is thus stabilized.

(5) In the movement of the head unit 30 in the scanning direction RA, the droplets Fb that have received the laser beams B reach the positions opposed to the laser head 34 after the positions opposed to the suction port 33. In other words, after having been irradiated with the laser beams B, the droplets Fb reliably reach the positions immediately below the suction port 33 before the positions immediately below the laser head 34. The evaporated elements Ev are thus reliably removed by suction through the suction port 33 before reaching the laser head 34 (the reflective mirror M). This allows the suction port 33 and the laser head 34 to move above the mother substrate 2M without varying the optical characteristics of the reflective mirror M. The productivity for forming the identification codes 10 is thus enhanced.

(6) When the head unit 30 moves in the scanning direction RA, the evaporated elements Ev from the droplets Fb that have received the laser beams B are drawn through the suction port 33, which is located rearward from the ejection head 32. That is, the evaporated elements EV from the droplets Fb are drawn in the direction opposite to the movement direction of the nozzles N. The evaporated elements Fv are thus further quickly separated from the nozzles N. In this manner, contamination of the nozzles N by the evaporated elements Ev is further reliably avoided, stabilizing ejection of droplets.

The illustrated embodiment may be modified in the following forms.

In the illustrated embodiment, the ejection head 32, the suction port 33, and the laser head 34 move relative to the mother substrate 2M. However, for example, the ejection head 32, the suction port 33, and the laser head 34 may be fixed and the mother substrate 2M (specifically, the mounting table 25L, 25R on which the mother substrate 2M is mounted) may be moved relative to the ejection head 32, the suction port 33, and the laser head 34.

The ejection head 32, the suction port 33, and the laser head 34 do not necessarily have to be formed as a single head unit but may be provided independently from one another as long as the ejection head 32, the suction port 33, and the laser head 34 are each movable relative to the mother substrate 2M or the mother substrate 2M is movable relative to the ejection head 32, the suction port 33, and the laser head 34.

In the illustrated embodiment, the suction port 33 is provided between the laser head 34 and the radiating positions PT. However, the suction port 33 may be arranged, for example, immediately above the radiating positions PT.

In the illustrated embodiment, the movement device (the movement mechanism) is embodied as the SCARA robot 26. However, the movement device may be a mounting table that carries and moves the mother substrate 2M relative to the laser head 34 or a carriage that carries and moves the laser head 34 relative to the mother substrate 2M. That is, the movement device may be embodied in any suitable forms, as long as relative movement between the suction port 33 and the mother substrate 2M or the laser head 34 and the mother substrate 2M occurs.

In the illustrated embodiment, the droplets Fb are dried and baked by the laser beams B. However, the droplets Fb may be caused to flow in a desired direction by energy produced by the radiated laser beams B. Alternatively, the droplets Fb may be fixed by radiating the laser beams B onto only the periphery of the droplets Fb. That is, any suitable method may be employed, as long as marks formed by the droplets Fb are provided through radiation of the laser beams B.

Although each of the dots D has the semispherical shape in the illustrated embodiment, oval dots or linear marks may be provided according to the present invention.

In the illustrated embodiment, the ejected droplets Fb form the dots D that define each of the identification codes 10. However, the droplets Fb may form, for example, different types of thin films, metal wirings, or color filters of various types of displays such as the liquid crystal display 1 or a field effect type device (an FED or an SED). The field effect type device has a flat electron release element that emits light from a fluorescent substance. That is, the droplet ejection apparatus is applicable to any suitable uses, as long as marks are formed by the ejected droplets Fb.

In the illustrated embodiment, the target onto which the droplets Fb are ejected is embodied as the mother substrate 2M. However, the target may be a silicone substrate, a flexible substrate, or a metal substrate. In other words, as long as marks are formed by the ejected droplets Fb, any suitable targets may be selected.

1. A droplet ejection apparatus comprising:
a droplet ejection head that ejects a droplet of a liquid onto a target;
a laser radiation device that radiates a laser beam onto an area on the target opposed to the droplet ejection head; and
a suction device that is arranged between the laser radiation device and a radiating position on the target at which the laser beam is radiated, and draws an element that has evaporated from the droplet.

2. The apparatus according to claim 1, further comprising a movement device, wherein the movement device moves at least one of the target and the laser radiation device relative to the other in such a manner that the droplet reaches the radiating position after having been received by the target, and moves at least one of the target and the suction device relative to the other in such a manner that the droplet reaches a position opposed to the suction device after having been irradiated with the laser beam at the radiating position.

3. The apparatus according to claim 2, wherein the movement device performs relative movement in such a manner that the droplet that has been irradiated with the laser beam becomes opposed to the laser radiation device after having been opposed to the suction device.

4. The apparatus according to claim 2, wherein the movement device is an articulated robot that moves at least one of the suction device, the laser radiation device, and the droplet ejection head above the target.

5. The apparatus according to claim 1, further comprising a head unit in which the droplet ejection head, the suction device, and the laser radiation device are mounted, wherein the suction device is arranged between the droplet ejection head and the laser radiation device.

6. The apparatus according to claim 5, further comprising a movement device that moves the head unit above the target in such a manner that the droplet ejection head precedes the suction device and the suction device precedes the laser radiation device.

7. The apparatus according to claim 1, the laser radiation device including:
a laser that radiates the laser beam; and
an optical system that guides the laser beam radiated by the laser to the radiating position in a deflecting manner.

8. The apparatus according to claim 1, wherein the flow resistance of a gas in a zone between the droplet ejection head and the target is greater than the flow resistance of the gas in a zone around the zone between the droplet ejection head and the target.

9. A droplet ejection apparatus comprising:
a head unit, wherein the head unit includes:
a droplet ejection head that ejects a droplet of a liquid onto a target;
a laser radiation device that radiates a laser beam onto an area on the target opposed to the droplet ejection head; and
a suction port that is arranged between the droplet ejection head and the laser radiation device, and draws an element that has evaporated from the droplet through radiation of the laser beam; and
a movement device that moves the head unit above the target in such a manner that the droplet ejection head precedes the suction port and the suction port precedes the laser radiation device.

10. The apparatus according to claim 9, wherein the laser radiation device includes:
a laser that radiates the laser beam; and
an optical system that guides the laser beam radiated by the laser to the area on the target opposed to the droplet ejection head.
